(19) United States
(12) Patent Application Publication
(10) Pub. No.: US 2013/0073999 A1
(43) Pub. Date: Mar. 21, 2013

(54) TOOL BARS ALONG LATERAL EDGES OF A MOBILE COMPUTING DEVICE DISPLAY

(71) Applicants: Arthur Frederick Swanson, Cary, NC (US); Anthony Edward Stuart, Wake Forest, NC (US); Christy Jill Reed, Raleigh, NC (US); Eric Robert Wald, Raleigh, NC (US); Maxwell Adam Ross, Evanston, IL (US)

(72) Inventors: Arthur Frederick Swanson, Cary, NC (US); Anthony Edward Stuart, Wake Forest, NC (US); Christy Jill Reed, Raleigh, NC (US); Eric Robert Wald, Raleigh, NC (US); Maxwell Adam Ross, Evanston, IL (US)

(21) Appl. No.: 13/621,072

(22) Filed: Sep. 15, 2012

Related U.S. Application Data
(63) Continuation of application No. 13/198,056, filed on Aug. 4, 2011.
(60) Provisional application No. 61/400,883, filed on Aug. 4, 2010.

(51) Int. Cl. G06F 3/048

(52) U.S. Cl. 715/779

(57) ABSTRACT

Tool bars are provided along lateral edges of a display of a handheld computing device. The tool bars include icons that represent application features. The user may interact with the application by touching the icons on the display. Since mobile computing devices are commonly held at the lateral sides of the device, navigation and activation buttons are in close proximity to a natural location of a user's thumbs. The proximity of the tool bars to the thumbs increases efficiency and accuracy when interacting with the application. The tool bars may be displayed in an expanded state such that a text label may be displayed to identify the application feature that each icon represents. The tool bars may also include functionality that displays additional information for any of the application features represented by the icons without navigating the application away from the current screen.

### CROSS-REFERENCE TO RELATED APPLICATION

The present application is a U.S. continuation patent application of, and claims priority under 35 U.S.C. §120 to, U.S. nonprovisional patent application Ser. No. 13/198,056, filed Aug. 4, 2011, which nonprovisional patent application published as U.S. patent application publication no. 2012/0036471, which patent application and any patent application publications thereof are incorporated by reference herein, and which '056 application is a U.S. nonprovisional patent application of, and claims priority under 35 U.S.C. §119(e) to, U.S. provisional patent application Ser. No. 61/400,883, filed Aug. 4, 2010, which is hereby incorporated herein by reference in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### FIELD OF THE INVENTION

The invention relates generally to tool bars positioned along lateral sides of a display of a mobile computing device.

### BACKGROUND OF THE INVENTION

A slate computer is a mobile personal computer that is equipped with a touch screen user interface such that a dedicated keyboard is not required for user input. For text input, users commonly touch an on-screen keyboard using fingertips. The reduced form factor provided by a slate computer enhances its mobility. Such enhanced mobility provides advantages at locations where conventional laptop computers are impractical or unwieldy, or do not provide the desired functionality. Many applications, such as those used in the healthcare profession and those requiring substantive field work, are well-suited for adapting the convenience and mobility afforded by slate computers since users do not commonly remain in one location for any length of time. Accordingly, slate computer functionality may be improved by enhancement of mobility features.

### SUMMARY OF THE INVENTION

The invention generally provides tool bars positioned along lateral edges of a display of a mobile computing device. Traditional tool bar locations may be provided along the top or bottom edges of the display screen. These locations have been maintained in the design of user interfaces in existing mobile devices. Mobile computing devices, especially slate devices, are commonly held at the lateral sides of the device. By providing tool bars at both lateral sides of the mobile device display, tool bar icons corresponding to primary navigation and action buttons are in close proximity to the natural location of a user's hands especially the user's thumbs. The proximity of the tool bars to the thumbs dramatically increases efficiency and accuracy when interacting with an application.

In one feature of the invention, the tool bars may be displayed in an expanded or collapsed state. When expanded, the tool bars may be displayed with a text label identifying an application feature represented by each icon; when collapsed, only the icons are displayed in the tool bar. These two states allow a user to easily identify the toolbar icons, while also allowing experienced users to maximize screen real estate.

In another feature of the invention, a user may select to display additional information associated with an application feature represented by a specific tool bar icon. In response to the selection, an expanded view of the application feature that the icon represents may be displayed without navigating the application away from the current screen. For example, in response to icon selection, a drop-down menu of selectable features may be displayed next to the selected icon.

In accordance with embodiments of the invention, a computer-implemented method provides a tool bar on a lateral edge of a display of a handheld computing device. The display includes a horizontal top edge, a horizontal bottom edge, and two vertical lateral edges. The method includes activating an application on the computing device using a processor. A tool bar is output to the display using the processor. The tool bar is provided on the display proximate at least one lateral edge of the display. The tool bar includes several icons, each icon representing a feature of the activated application. User input is received when one of the icons on the tool bar is activated by a user. In response to the user input, the tool bar may be expanded, collapsed, or additional information associated with an application feature represented by at least one of the icons may be displayed.

In accordance with other embodiments of the invention, a handheld computing device includes a processor and a display including a horizontal top edge, a horizontal bottom edge, and two vertical lateral edges. The processor is configured to activate an application and provide a tool bar on at least one lateral edge of the display. The tool bar includes a plurality of icons, each of which represents a feature of the activated application. User input is received when one of the icons on the tool bar is activated by a user. In response to the user input, the tool bar may be expanded, collapsed, or additional information associated with an application feature represented by at least one of the icons may be displayed on the display.

The invention pertains to cooking grills comprising a housing defining a cooking chamber and a door hinged at a bottom thereof, a heating element disposed in the cooking chamber, a cooking surface slidably disposed to slide in and out of the housing through the door.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures.

FIG. 1 illustrates a block diagram of a computer system that may be used to practice embodiments of the present invention.

FIG. 2 illustrates a display of a mobile computing device with tool bars provided on lateral edges thereof in a collapsed state.

FIG. 3 illustrates a display of a mobile computing device with tool bars provided on lateral edges thereof in an expanded state.

FIG. 4 illustrates a display of a mobile computing device with tool bars provided on lateral edges thereof with additional information displayed for one tool bar icon.

FIG. 5 is a flow diagram illustrating a method for providing tool bars on lateral edges of a mobile computing device display.

### DETAILED DESCRIPTION

The detailed description of exemplary embodiments of the invention herein makes reference to the accompanying drawings, which show the exemplary embodiment by way of illustration. While these exemplary embodiments are described in sufficient detail to enable those skilled in the art to practice the invention and reveal the best mode of doing so, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention provides tool bars along lateral edges of a mobile computing device display, rather than along top and bottom edges of the display. Many mobile devices are commonly held at the lateral sides of the device such that a user may interact with an application interface using his thumbs. By providing the tool bars along the lateral edges of the mobile device display, primary navigation and action buttons are provided in close proximity to the natural location of the user's thumbs resulting in increased efficiency and accuracy while the user interacts with an application.

In one feature of the invention, the tool bars may be displayed in a collapsed or expanded state. When the tool bars are displayed in a collapsed state, the tool bars are displayed only with icons representing a specific application feature. In the expanded state, a text label identifying a specific application feature of each icon may be provided. The collapsed/expanded states allow a user to control the level of detail displayed by the tool bar icons and the amount of screen space consumed by the tool bars.

In another feature of the invention, a user may select to have application feature information displayed on-screen in addition to the icon data that is displayed in the expanded tool bar state. The additional displayed information provides a view into the application feature that the icon represents without navigating the application away from the current screen. The additional information may be displayed in the form of a drop-down menu such that a user may activate functionality of the application feature represented by the icon by selecting a corresponding menu item.

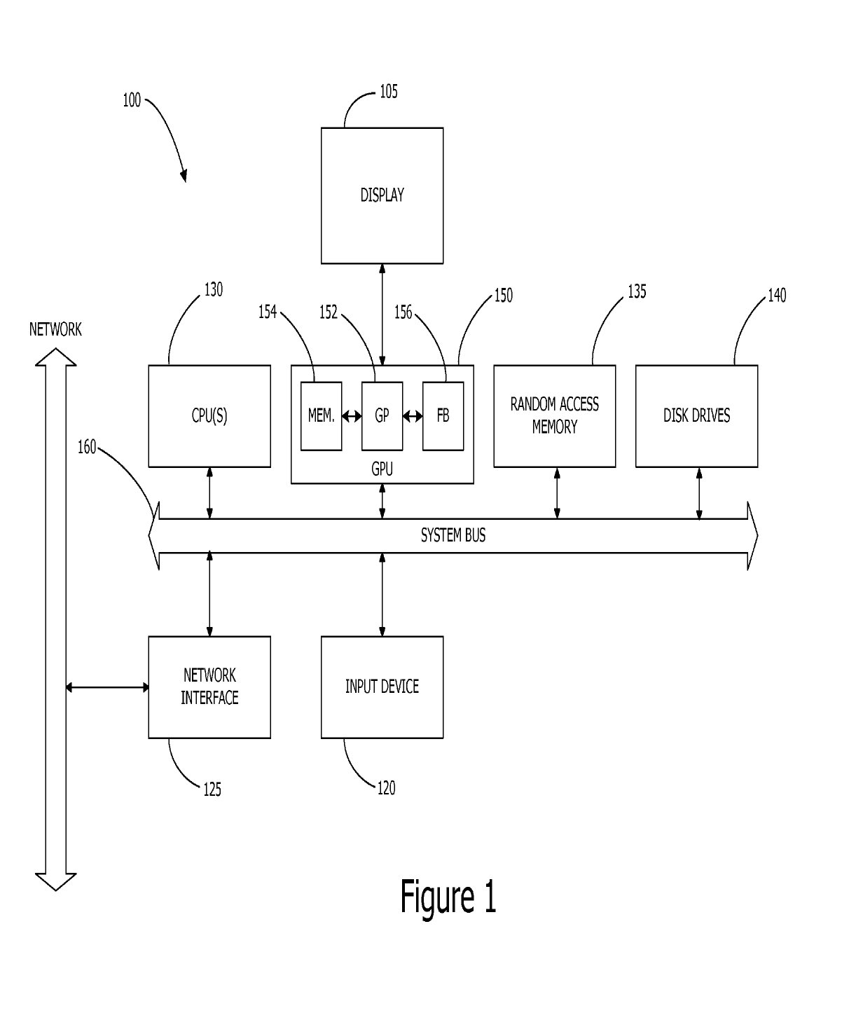

Turning to the drawings, FIG. 1 illustrates a block diagram of a computer system that may be used to practice embodiments of the present invention. FIG. 1 is merely illustrative of an embodiment incorporating the present invention and does not limit the scope of the invention as recited in the claims. One of ordinary skill in the art would recognize other variations, modifications, and alternatives.

In one embodiment, computer system 100 typically includes a display 105, an input device 120, and a network interface 125. In accordance with embodiments of the invention, the computer system 100 is a mobile computing device such as a slate computer. The input device 120 is typically a touch screen application that allows a user to select objects, icons, text and the like that appear on the display 105 via a command activated by touching the display 105 using fingertips.

In various embodiments, computer system 100 typically includes familiar computer components such as one or more central processing units (CPU) 130, memory storage devices, such as a random access memory (RAM) 135 and disk drives 140, a graphics processing unit (GPU) 150, and a system bus 160 interconnecting the computer components.

Embodiments of the invention may take the form of a computer program product on a tangible, computer-readable storage medium having computer-readable program code means embodied in the storage medium. RAM 135 and the disk drives 140 are examples of tangible media configured to store data such as image files, models including geometrical descriptions of objects, ordered geometric descriptions of objects, procedural descriptions of models, scene descriptor files, shader code, a rendering engine, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), magnetic storage devices, battery-backed volatile memories, networked storage devices, and the like.

In some embodiments of the present invention, GPU 150 may be any conventional graphics processing unit that may be user programmable. In this example, GPU 150 includes a graphics processor 152, a number of memories and/or registers 154, and a number of frame buffers 156.

FIG. 1 is representative of a computer system capable of embodying the present invention. It will be readily apparent to one of ordinary skill in the art that many other hardware and software configurations are suitable for use with the present invention. For example, the computer system may be a series of networked computers.

Embodiments of the invention are described herein in terms of functional block components, screen shots, optional selections and various processing steps. It should be appreciated that such functional blocks may be realized by any number of hardware and/or software components configured to perform the specified functions. For example, the invention may employ various integrated circuit components (e.g., memory elements, processing elements, logic elements, look-up tables, etc.), which may carry out a variety of functions under the control of one or more microprocessors or other control devices. Similarly, the software elements of the invention may be implemented with any programming or scripting language, with the various algorithms being implemented with any combination of data structures, objects, processes, routines or other programming elements. Further, it should be noted that embodiments of the invention may employ any number of conventional techniques for data transmission, signaling, data processing, network control, and the like.

As will be appreciated by one of ordinary skill in the art, embodiments of the invention may be embodied as a customization of an existing system, an add-on product, upgraded software, a stand alone system, a distributed system, a method, a data processing system, a device for data processing, and/or a computer program product. Accordingly, embodiments of the invention may take the form of an entirely software embodiment, an entirely hardware embodiment, or an embodiment combining aspects of both software and hardware.

As stated, embodiments of the invention are described herein with reference to screen shots, block diagrams and flowchart illustrations of methods, apparatus (e.g., systems), and computer program products. It will be understood that each functional block of the block diagrams and the flowchart illustrations, and combinations of functional blocks in the block diagrams and flowchart illustrations, can be implemented by computer program instructions.

These computer program instructions may be loaded onto a general purpose computer, a special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implements the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

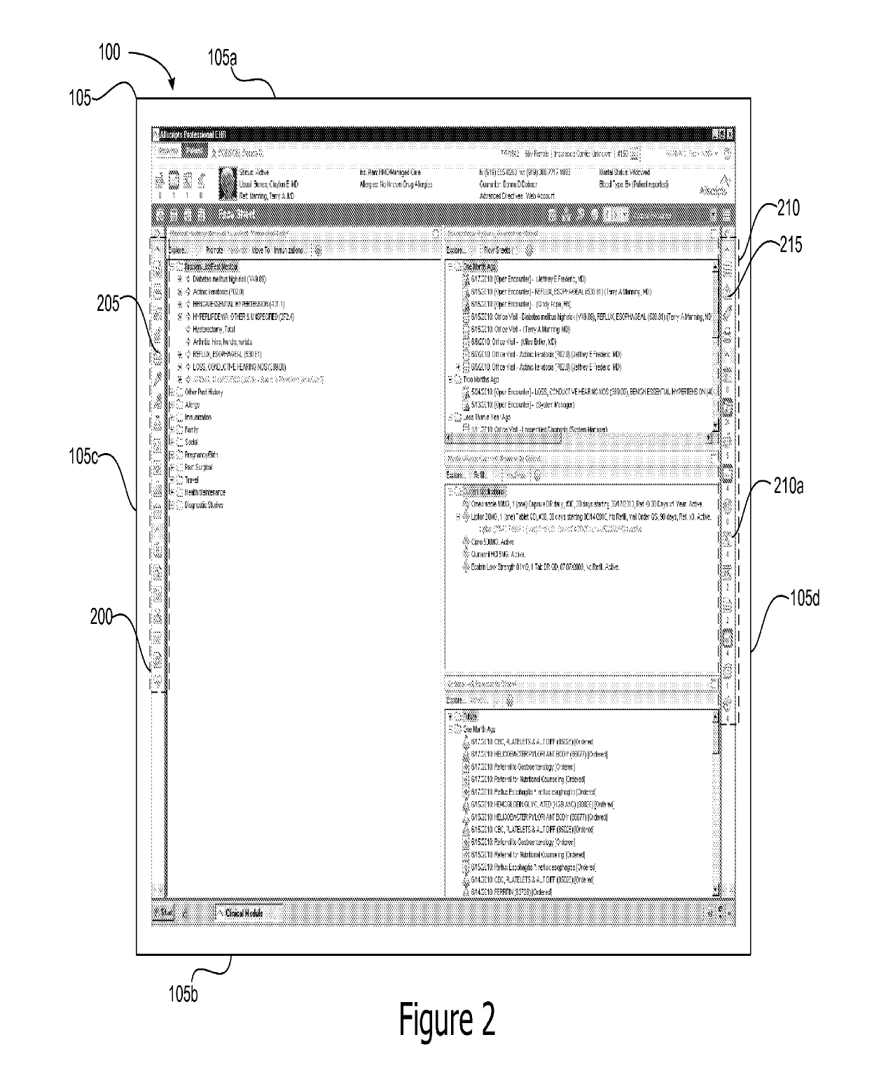

FIG. 2 illustrates a display of a mobile computing device with tool bars provided on lateral edges thereof in a collapsed state. The mobile computing device 100 is shown as a slate computer with the display 105 having a top edge 105a, a bottom edge 105b and two lateral edges 105c, 105d. However, it is understood that the embodiments of the invention may be used with other types of computing devices. In operation, a user commonly grasps the lateral edges 105c, 105d of the mobile computing device 100. As shown in FIG. 2, the mobile computing device 100 is positioned with a landscape orientation. However, embodiments of the present invention are also applicable to a portrait orientation of the computing device 100 without departing from the scope of the invention. In the portrait orientation, the shorter edges of the display 105 become the top and bottom edges 105a, 105b, and the longer edges of the display 105 become the lateral edges 105c, 105d.

When a user launches an application, tool bars 200, 210 are provided along the opposite lateral edges 105c, 105d of the display 105. Each tool bar 200, 210 includes a number of icons 205, 215 that each represent a feature of the application. By providing the tool bars 200, 210 along the lateral edges 105c, 105d of the display 105, the user may hold the mobile computing device 100 and activate an application feature represented by any icon 205, 215 on the tool bars 200, 210 using one of his thumbs.

In the embodiment of the invention shown in FIG. 2, the tool bars 200, 210 provide an interface with an application used in the healthcare industry. However, embodiments of the invention are not so limited as the toolbars provided on the lateral edges 105c, 105d may be used with any type of computer application. The application displays general patient information along the top edge 105a of the display 105, and information associated with a patient's medical history on a left portion of the display 105. The application may also display specific information associated with patient encounters, medications, and orders on a right portion of the display 105.

Some of the icons, such as those shown in the bottom portion of the tool bar 210, may be displayed with a number that indicates a numerical tally associated the corresponding application feature. For example, the icon 210a may be associated with refill requests for the patient. The “4” displayed just below the icon 210a indicates that four refill requests have been submitted for the patient.

The tool bars 200, 210 shown in FIG. 2 are displayed in a collapsed state. In the collapsed state, only the icons (and, in some cases, the corresponding numerical tally) are displayed in the tool bar. The collapsed tool bars 200, 210 are useful for users who are familiar with the application features represented by the icons. The tool bars 200, 210 in the collapsed state provide more space on the display 105 for the user to interact with other application features because the display space consumed by the tool bars 200, 210 is minimized. However, new users may be unfamiliar with the specific application features that the icons represent.

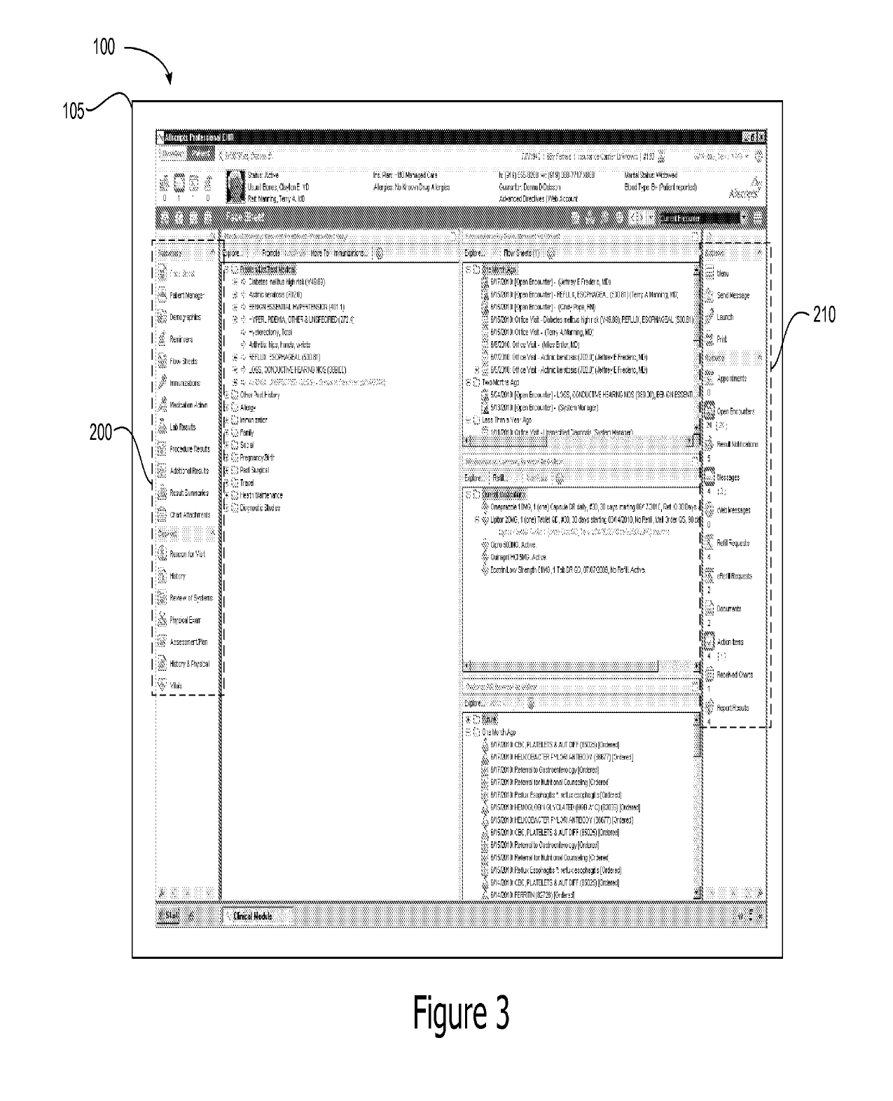

FIG. 3 illustrates the display of the mobile computing device with the tool bars provided on lateral edges thereof in an expanded state. The expanded tool bars 200, 210 identify specific application features represented by each icon. Specifically, the expanded tool bars 200, 210 may identify icon groups under headings (e.g., summary, contact, actions and queues) and may include a brief description of the application features represented the icons.

For example, as shown in the tool bar 200, the icons that are grouped under a “summary” heading may correspond to application features associated with a patient's medical history. These icons may be labeled as “face sheet”, “patient manager”, “demographics”, “reminders”, “flow sheets”, “immunizations”, and the like. Other icons in the tool bar 200 that are grouped under a “contact” heading include application features associated with the patient's current visit. These icons may be labeled as “reason for visit”, “history”, “review of systems”, “physical exam”, and the like. At least some of the icons that are grouped under the “contact” heading may correspond to an application feature that inserts data collected during the patient's current visit to that patient's chart.

As shown in the tool bar 210, the icons that are grouped under an “actions” heading may correspond to application features unrelated to specific patient data. These icons may be labeled as “menu”, “send message”, “launch”, “print”, and the like. Other icons in the tool bar 210 that are grouped under a “queues” heading may include application features that may be activated more than once such that a numerical tally may be useful to record and access. These icons may be labeled as “appointments”, “open encounters”, “result notifications”, “messages”, and the like.

In some embodiments, the tool bars 200, 210 may be activated to display additional information associated with a specific application feature. A user may select to display the additional information associated with any of the tool bar icons without navigating the application away from the current screen shown on the display 105.

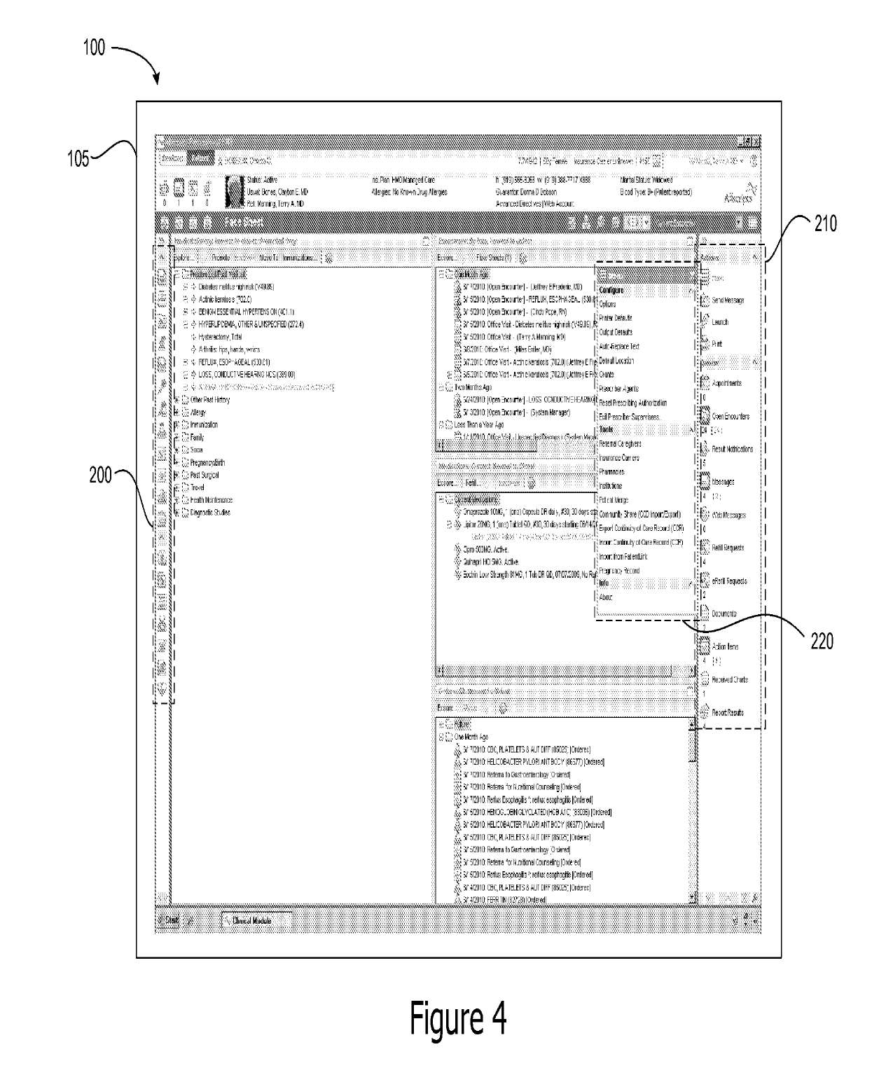

FIG. 4 illustrates the display of the mobile computing device with the tool bars provided on lateral edges thereof with additional information displayed for one tool bar icon. The additional information is displayed in the form of a drop down menu 220 such that a user may activate other application features associated with a selected icon by selecting one of the menu items. The additional information may be displayed in response to user selection of the corresponding tool bar icon such that the additional information may be conveniently accessed and selected by the user's thumb. As shown in FIG. 4, the “menu” action has been expanded in response to user selection such that the additional information displayed in the drop down menu 220 includes different selectable features associated with the “menu” action. The selectable features are categorized under different headings such as “configure”, “tools” and “info”.

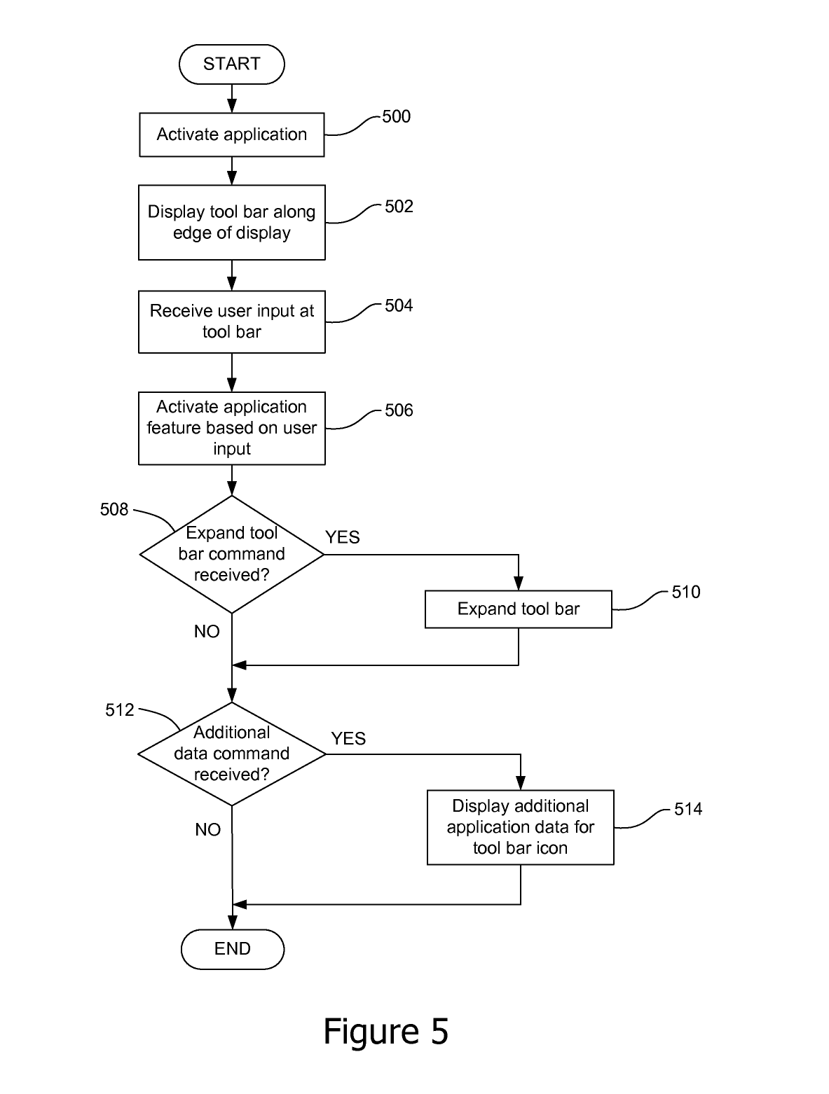

FIG. 5 is a flow diagram illustrating a method for providing tool bars on lateral edges of a mobile computing device display. The method begins when an application is activated on a mobile computing device (step 500).

Upon activation of the application, a tool bar is provided along a lateral edge of the display of the mobile computing device (step 502). In some embodiments, a tool bar is provided on each lateral edge of the display.

By providing the tool bars on the lateral edges of the display, a user may easily activate application features with her thumbs while holding the sides of the mobile computing device. Since the tool bars include primary navigation and action touch-screen buttons displayed as icons representing application features, the user may conveniently interact with the application because the buttons are placed in close proximity to the natural location of the user's hands. Specifically, user input is received when the user touches an icon on one of the tool bars using her thumb (step 504).

In response to receiving the user input, an application feature corresponding to the touched tool bar icon is activated (step 506).

When the application is launched, the tool bars may appear in a collapsed state, which means that only the application feature icons are shown in the tool bars. In some cases, a numerical tally associated with the application feature represented by the icon is also displayed on the tool bar proximate the corresponding icon. The numerical tally may correspond, for example, to a message count or a task count. In the collapsed tool bar state, available display space is maximized.

While the application is executing, a determination is made whether user input is received to expand the tool bar (step 508). The user may input a command to expand the tool bar by activating a touch-screen button on the display proximate the tool bar. If a command is received to expand the tool bar, the tool bar is displayed in the expanded mode (step 510). In the expanded mode, each icon on the tool bar may be displayed with a text label that identifies the application feature represented by that icon. The user may cause the expanded tool bar to collapse by reactivating the corresponding touch-screen button.

Also during application execution, a determination is made whether user input is received to provide additional application feature information (step 512). If a command is received to provide additional information about an application feature, the additional information is displayed proximate the tool bar icon representing that application feature without navigating the application away from the current screen (step 514). For example, a drop-down menu may be displayed in response to receiving user input to provide additional information associated with the tool bar icon (e.g., the user touches the appropriate tool bar icon with her thumb.) The user may then select one of the menu items to execute a corresponding action of the application feature represented by the tool bar icon. The application continues executing in response to additional user input at the tool bars until the application is terminated.

Moving tool bar locations from a top or bottom of a display to the left and right lateral edges provides the tool bars at a location where a user's hands are most frequently positioned when holding a mobile computing device such as a slate computer. The tool bar proximity to the user's thumbs increases efficiency and accuracy during user interaction with an application. In addition, the expansion/contraction of the tool bars allows a user to control a level of tool bar detail and the amount of display space consumed by the tool bars. Furthermore, the display of additional information associated with a tool bar icon may provide easy access to frequently used data or functionality.

Although the present invention is described with respect to a slate computer, the invention is not so limited. That is, it is contemplated that the invention may be used with any mobile computing device that a user is likely to hold along lateral sides.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims. All structural and functional equivalents to the elements of the above-described exemplary embodiments that are known to those of ordinary skill in the art are expressly incorporated herein by reference and are intended to be encompassed by the present claims. Further, no element described herein is required for the practice of the invention unless expressly described as “essential” or “critical.”

It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

1. A computer-implemented method to provide a tool bar on a lateral edge of a display of a handheld computing device, the display comprising a horizontal top edge, a horizontal bottom edge, and two vertical lateral edges, the method comprising: activating an application on the computing device, wherein the application is activated by a processor; and outputting a tool bar to the display using the processor, wherein the tool bar is provided on the display proximate at least one lateral edge of the display, wherein the tool bar comprises a plurality of icons, each icon representing a feature of the activated application.

2. The method of claim 1 further comprising: receiving user input in response to one of the icons on the tool bar being activated by a user, wherein the icon is activated in response to the user touching the icon on the tool bar.

3. The method of claim 1 further comprising: expanding the tool bar in response to user input.

4. The method of claim 3, wherein the icons of the expanded tool bar are provided with a text label that identifies the feature of the activated application that the icon represents.

5. The method of claim 3 further comprising: collapsing the expanded tool bar in response to user input.

6. The method of claim 1 further comprising: displaying additional information associated with an application feature represented by at least one of the icons in response to user input.

7. The method of claim 6, wherein the additional information is displayed without navigating the application away from a current output to the display.

8. The method of claim 6, wherein the additional information is displayed in the form of a drop-down menu.

9. The method of claim 6, wherein the drop-down menu comprises selectable items that, when selected in response to user input, cause the activated application to execute an action that corresponds to the selectable item.

10. The method of claim 1, wherein each icon corresponds to a navigation feature or an action to be executed by the activated application.

11. The method of claim 1 further comprising: displaying a number in the tool bar proximate at least one of the icons, wherein the number corresponds to a numerical tally associated with the feature of the activated application represented by the icon.

12. A handheld computing device comprising: a display comprising a horizontal top edge, a horizontal bottom edge, and two vertical lateral edges; and a processor configured to: activate an application, and output a tool bar to the display such that the tool bar is provided proximate at least one lateral edge of the display, wherein the tool bar comprises a plurality of icons, each icon representing a feature of the activated application.

13. The computing device of claim 12, wherein the processor is further configured to receive user input in response to one of the icons on the tool bar being activated by a user.

14. The computing device of claim 12, wherein the processor is further configured to expand the tool bar in response to user input.

15. The computing device of claim 14, wherein the icons of the expanded tool bar are provided with a text label that identifies the feature of the activated application that the icon represents.

16. The computing device of claim 14 wherein the processor is further configured to collapse the expanded tool bar in response to user input.

17. The computing device of claim 12, wherein the processor is further configured to display additional information associated with an application feature represented by one of the icons in response to user input.

18. The computing device of claim 17, wherein the additional information is displayed without navigating the application away from a current output to the display.

19. The computing device of claim 17, wherein the additional information is displayed in the form of a drop-down menu.

20. The computing device of claim 19, wherein the drop-down menu comprises selectable items that, when selected in response to user input, cause the activated application to execute an action that corresponds to the selectable item.

21-22. (canceled)
